(19) United States
(12) Patent Application Publication
(10) Pub. No.: US 2009/0047995 A1
(43) Pub. Date: Feb. 19, 2009

(54) PORTABLE COMMUNICATION DEVICE HAVING A DUAL CAMERA MODULE WITH A COMMON IMAGE SENSOR ELEMENT

(75) Inventors: Paul Futter, Cary, NC (US); Alexander Hunt, Durham, NC (US)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: Sony Ericsson Mobile Communications AB, Lund (SE)

(21) Appl. No.: 11/946,566

(22) Filed: Nov. 28, 2007

Related U.S. Application Data
(60) Provisional application No. 60/955,943, filed on Aug. 15, 2007.

(51) Int. Cl. H04M 1/00

(52) U.S. Cl. 455/556.1

(57) ABSTRACT

A portable communication device is equipped with a dual camera module having a first or main camera module, a second or video telephony camera module and a common image sensor element configured to receive images from the first and second camera modules. The dual camera module includes image-shifting optics configured to shift images from the second camera module onto a portion of a common image sensor such that images from the main camera module may be received by a first or main portion of the common image sensor and images from the second camera module may be received by a secondary portion of the common image sensor.

### RELATED APPLICATION DATA

The present application claims the benefit of U.S. Provisional Application Ser. No. 60/955,943, filed Aug. 15, 2007, the disclosure of which is herein incorporated by reference in its entirety.

### TECHNICAL FIELD OF THE INVENTION

The present invention relates generally to portable communication devices, and more particularly, to a portable communication device having a dual camera module with a common image sensor element.

### DESCRIPTION OF RELATED ART

In recent years, portable communication devices, such as mobile phones, personal digital assistants, mobile terminals, etc., continue to grow in popularity. As the popularity of portable communication devices continues to grow, today's wireless landscape is rapidly changing as mobile phones and networks are being enhanced to provide features and services beyond voice communications. The wireless industry is experiencing a rapid expansion of mobile data services and enhanced functionality. In addition, the features associated with certain types of portable communication devices have become increasingly diverse. To name a few examples, many portable communication devices have text messaging capability, Internet browsing functionality, electronic mail capability, video playback capability, audio playback capability, image display capability and hands-free headset interfaces.

With the popularization of digital cameras, many portable communication devices are equipped with relatively small digital cameras contained within the camera housing. In addition, some Universal Mobile Telecommunications System (UMTS) mobile phones are equipped with two camera modules. Typically, one camera module has a first image sensor element, and provides two- or three-megapixel resolution for still and video imaging, while the other camera module, e.g., a lower resolution Video Graphics Array (VGA) or Quarter Common Intermediate Format (QCIF) camera module, has a second image sensor element, and may be used for video conferencing.

### SUMMARY

The present invention provides a portable communication device having a dual camera module with a common sensor element. The dual camera module includes a main camera module and a video conferencing or video telephony camera module. Focusing optics are employed to direct images from the main camera module onto a main portion of the single sensor element. Image-shifting optics are employed to direct images from the secondary camera module onto a secondary portion of the single sensor element.

One aspect of the invention relates to a portable communication device that includes a housing, a display supported within a portion of the housing, and a dual camera module disposed within the housing. The dual camera module includes a first camera module positioned for capturing images adjacent to a first side of the housing, a second camera module positioned for capturing images adjacent to a second side of the housing, and a common image sensor element configured to receive images from the first camera module and the second camera module.

According to another aspect, the first camera module is positioned to direct captured images onto a main portion of the common image sensor element

According to another aspect, the dual camera module further comprises image-shifting optics configured to shift images from the second camera module onto a portion of the common image sensor element.

According to another aspect, the first camera module includes a camera configured to capture still and/or moving images.

According to another aspect, the second camera module is a video telephony module configured to capture video images.

According to another aspect, the second camera module is configured to capture images of a user of the portable communication device for use in a video telephony communications session.

According to another aspect, the first camera module includes a first camera aperture disposed within a rear side of the housing.

According to another aspect, the second camera module includes a second camera aperture disposed within a front side of the housing; and wherein the display is disposed on the front side of the housing.

According to another aspect, the portable communication device is a mobile telephone.

Another aspect of the invention relates to a portable communication device that includes a housing and a dual camera module within the housing, where the dual camera module includes a main camera module, a video telephony module, and a common image sensor element configured to receive images from the main camera module and the video telephony module.

According to another aspect, the main camera module is configured to direct captured images onto a main portion of the common image sensor element.

According to another aspect, the dual camera module includes image-shifting optics configured to shift images captured by the video telephony module onto a secondary portion of the common image sensor element.

According to another aspect, the main camera module includes a main camera aperture disposed within a first side of the housing, and the video telephony module includes a video telephony aperture disposed within a second side of the housing.

According to another aspect, the portable communication device is a mobile telephone.

Another aspect of the invention relates to a dual camera module for use with a portable communication device. The dual camera module includes a main camera module configured to capture still and/or moving images, a video telephony camera module configured to capture video images, and a common image sensor element configured to receive images from the main camera module and the video telephony camera module.

According to another aspect, the dual camera module includes image-shifting optics configured to direct images from the video telephony camera module onto a secondary portion of the common image sensor element.

According to another aspect, the main camera module is positioned to direct captured images onto a main portion of the common image sensor element

According to another aspect, the dual camera module includes image-shifting optics configured to direct images from the main camera module onto a secondary portion of the common image sensor element.

According to another aspect, the video telephony camera module is positioned to direct captured images onto a main portion of the common image sensor element.

According to another aspect, a mobile telephone includes a housing that supports a dual camera module.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended thereto.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF DRAWINGS

Many aspects of the invention can be better understood with reference to the following drawings. The components in the drawings are not necessarily to scale, emphasis instead being placed upon clearly illustrating the principles of the present invention. Likewise, elements and features depicted in one drawing may be combined with elements and features depicted in additional drawings. Moreover, in the drawings, like reference numerals designate corresponding parts throughout the several views.

FIG. 1 is a schematic front view of a mobile telephone as an exemplary portable communication device having a dual camera module;

FIG. 2 is a schematic rear view of the mobile telephone of FIG. 1;

FIG. 3 is a functional block diagram of an exemplary mobile telephone including a dual camera module;

FIG. 4 is a diagrammatic illustration of a dual camera module in accordance with one embodiment; and

FIG. 5 is a diagrammatic illustration of a dual camera module in accordance with another embodiment.

### DETAILED DESCRIPTION OF EMBODIMENTS

In the detailed description that follows, like components have been given the same reference numerals regardless of whether they are shown in different embodiments of the present invention. To illustrate the present invention in a clear and concise manner, the drawings may not necessarily be to scale and certain features may be shown in somewhat schematic form.

Many Universal Mobile Telecommunications System (UMTS) mobile phones include two camera modules. Typically, one module includes a first sensor element having two- or three-megapixel resolution for photography, while the other module includes a second sensor element having a lower resolution, e.g., Video Graphics Array (VGA) or Quarter Common Intermediate Format (QCIF) resolution, used for video conferencing. As mobile phone designs move into smaller and smaller form factors, an advantage may be found in eliminating components or reducing component size.

The present disclosure describes a portable communication device equipped with a dual camera module having a common image sensor element. The dual camera module includes a main camera module, e.g., a camera configured to capture still and moving images, and a secondary camera module, e.g., a video telephony module or video conferencing camera module. The dual camera module employs optics that are configured to direct images from the main camera module and the secondary camera module onto portions of a common image sensor element, thereby allowing for a lower profile camera module to accommodate a main camera and video telephony camera.

As referred to herein, the term “portable communication device” includes portable radio communication equipment. The term “portable radio communication equipment”, which herein after is referred to as a mobile phone, a mobile device, a mobile radio terminal or a mobile terminal, includes all electronic equipment, including, but not limited to, mobile telephones, pagers, communicators, i.e., electronic organizers, smartphones, personal digital assistants (PDAs), or the like. While the present invention is being discussed with respect to portable communication devices, it is to be appreciated that the invention is not intended to be limited to portable communication devices, and can be applied to any type of electronic equipment equipped with a dual camera module.

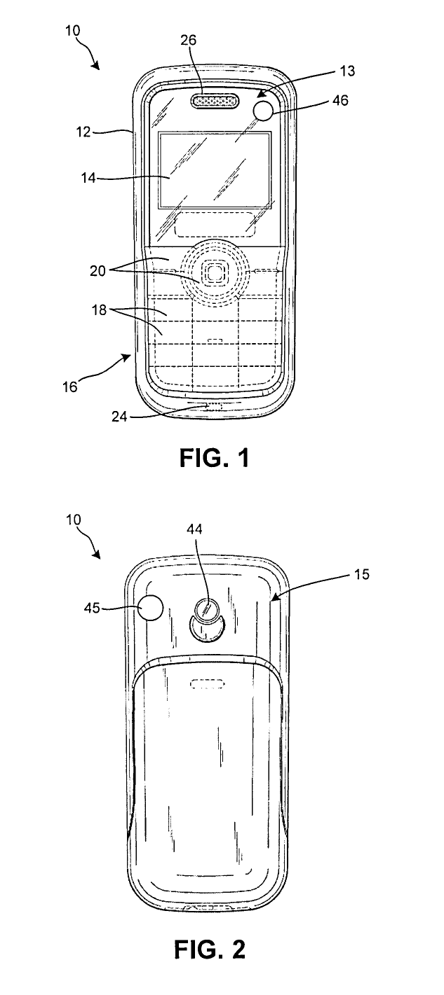

Referring initially to FIG. 1 and FIG. 2, a portable communication device 10 is shown in accordance with the present invention. In the exemplary embodiment described herein, the portable communication device is a mobile phone 10. Of course, it will be appreciated that the present invention is applicable to other portable communication devices. The mobile phone 10 is shown as having a “block” or “candy bar” type of housing 12, but it will be appreciated that other housing types, such as clamshell or slide-type housings may be utilized without departing from the scope of the present invention. The housing includes a first or front side 13 and a second or rear side 15.

The mobile phone 10 includes a display 14 and a keypad 16. The display displays information to a user, such as operating state, time, phone numbers, contact information, various navigational menus, etc., which enable the user to utilize the various features of the mobile phone 10. The display may also be used to visually display content received by the mobile phone 10 and/or retrieve from the memory of the mobile phone 10. In addition, an image or images may be displayed on the display 14, such as a photograph taken by a camera of the mobile phone 10, a video stream received by the mobile phone 10, or a photo preview image when the display 14 functions as an electronic viewfinder for the camera.

The keypad 16 may provide for a variety of user input operations. For example, the keypad 16 may include alphanumeric keys 18 for allowing entry of alphanumeric information, such as telephone numbers, phone lists, contact information, notes and the like. In addition, the keypad 16 may include special function keys 20, such as a “call send” key for initiating or answering a key or answering a call and a “call end” key for ending or “hanging up” a call. Special function keys 20 may also include menu navigation keys, for example, for navigating through a menu displayed on the display to select different telephone functions, profiles, settings, and the like, as is conventional. Other keys associated with the mobile phone may include a volume key, an audio mute key, an on/off power key, a web browser launch key, a camera key, a video conferencing key, and the like. Keys or key-like functionality may also be embodied as a touch screen associated with the display 14.

Artisans will appreciate that the mobile phone 10 further includes suitable circuitry and software for performing various functionality. The circuitry and software of the mobile phone is coupled with input devices, such as a keypad 16, the functional keys 18 and a microphone 24, as well as to the output devices, including the display 14 and a speaker 26.

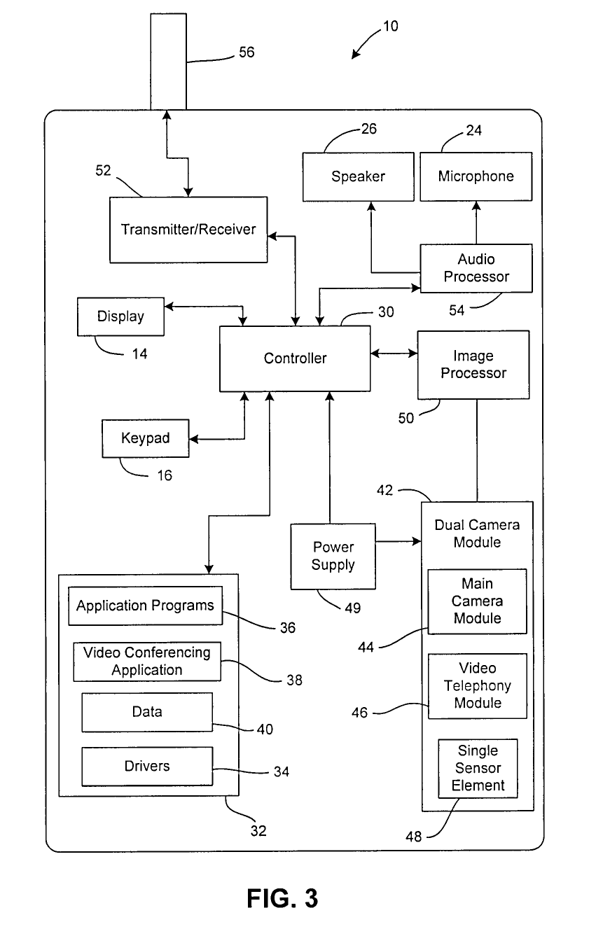

In the illustrated embodiment, the mobile phone 10 also includes a dual camera module 38 (FIG. 3). As is discussed more fully below, the dual camera module includes a main camera 44 (typically including a flash 45) and a secondary camera 46, such as a video conferencing camera or video telephony camera. As is described more fully below, the dual camera module is configured such that the main camera 44 and the secondary camera 46 may be used in conjunction with a common image sensor element, where appropriate optic direct images from both the main camera 44 and the secondary camera 46 onto the common image sensor element.

FIG. 3 represents a functional block diagram of a portable communication device 10, e.g., a mobile phone. The portable communication device 10 includes a controller 30 that controls the overall operation of the portable communication device. The controller 30 may include any commercially available or custom microprocessor or microcontroller. Memory 32 is operatively connected to the controller 30 for storing control programs and data used by the portable communication device. The memory 32 is representative of the overall hierarchy of memory devices containing software and data used to implement the functionality of the portable communication device in accordance with one or more aspects described herein. The memory 32 may include, for example, RAM or other volatile solid-state memory, flash or other non-volatile solid-state memory, a magnetic storage medium such as a hard disk drive, a removable storage media, or other suitable storage means. In addition to handling voice communications, the portable communication device 10 may be configured to transmit, receive and process data, such as text messages (also known as short message service or SMS), electronic mail messages, multimedia messages (also known as MMS), image files, video files, audio files, ring tones, streaming audio, streaming video, such as video generated during video conferencing or video telephony sessions, data feeds (e.g., podcasts) and so forth.

In the illustrated embodiment, memory 32 stores drivers 34, e.g., I/O device drivers, application programs 36, e.g., a video conferencing application program 38, and application program data 40. The I/O device drivers include software routines that are accessed through the controller 30 (or by an operating system (not shown) stored in memory 32) by the application programs 36, e.g., a video conferencing application program 38, to communicate with devices such as a display 14, a keypad 16, e.g., a standard keypad, a QWERTY keypad or a touch screen keypad, a dual camera module 42, as well as other input/output ports. As is described more fully below, the dual camera module 42 may include a main camera module 44 and a secondary camera module 46 (also referred to herein as a video telephony module or a video conferencing camera), and a common image sensor element 48. The dual camera module may be operatively coupled to an image processor 50, and configured to provide still and/or video camera functionality along with video telephony functionality, while making use of a common image sensor element 48. A power supply 49, typically including a battery, provides power to the various parts of the mobile phone, such as the display and the dual camera module, for carrying out the various functionality of the mobile phone.

The application programs comprise programs that implement various features of the portable communication device 10, such as voice calls, video conferencing or other video telephony applications, e-mail, Internet access, multimedia messaging, contact manager and the like.

With continued reference to FIG. 3, the controller 30 interfaces with the aforementioned display 14, keypad 16 and dual camera module 42 (and any other user interface device(s)), a transmitter/receiver 52 (often referred to as a transceiver), audio processing circuitry, such as an audio processor 54, and a position determination element or position receiver, such as a global positioning system (GPS) receiver. Image, audio and/or video files may be stored in memory 32.

An antenna 56 is coupled to the transmitter/receiver 52 such that the transmitter/receiver 52 transmits and receives signals via antenna 56, as is conventional. The mobile phone may include an audio processor 54 for processing the audio signals transmitted by and received from the transmitter/receiver. Coupled to the audio processor 54 are a microphone 24 and a speaker 26, which enable a user to listen and speak via the portable communication device. Audio data may be passed to the audio processor 54 for playback to the user. The audio processor 54 may include any appropriate buffers, decoders, amplifiers and the like.

The portable communication device also may include one or more local wireless interfaces, such as an infrared transceiver and/or an RF adapter, e.g., a Bluetooth adapter, WLAN adapter, Ultra-Wideband (UWB) adapter and the like, for establishing communication with an accessory, a hands free adapter, e.g., a headset that may audibly output sound corresponding to audio data transferred from the portable communication device 10 to the adapter, another mobile radio terminal, a computer, or any other electronic device. Also, a wireless interface may be representative of an interface suitable for communication within a cellular network or other wireless wide-area network (WWAN).

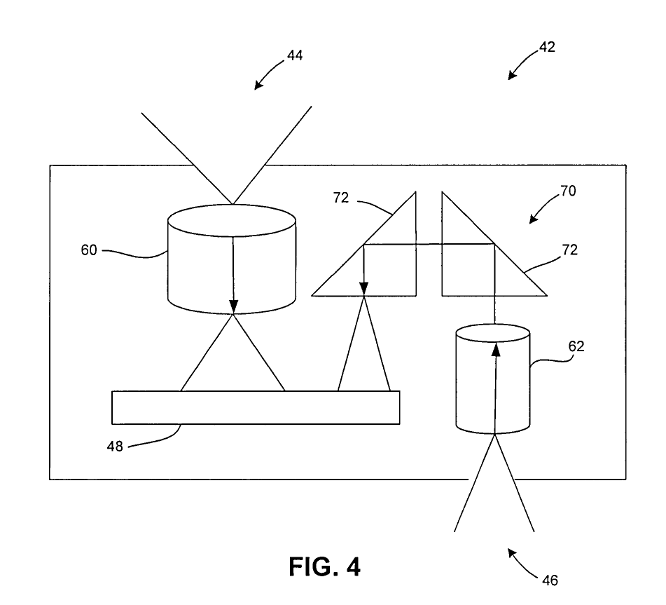

Referring now to FIG. 4, an exemplary dual camera module 42 is depicted. The dual camera module 42 includes a first or main camera module (referred to generally as 44), and a secondary camera module (referred to generally as 46). The dual camera module 42 includes a common image sensor element 48 that is configured to receive images from the main camera module 44 and the secondary camera module 46. The common image sensor element 48 may include any suitable imaging element, such as a solid-state imaging element, e.g., CCD (charged coupled device) or a CMOS (complimentary metal oxide semiconductor). The dual camera module 42 is configured such that the common image sensor element 48 may be used to capture images from both the main camera module 44 and the secondary camera module 46.

The main camera module may include any camera that is operable to capture still and/or video images while housed within the portable communication device. In one exemplary embodiment, the main camera module includes a suitable focusing lens 60, e.g., a zoom lens, for forming a main camera image on a main portion of the common image sensor element 48. As is shown in FIG. 2, the main camera module may include a first or main camera aperture in the rear side 15 of the mobile phone housing 12.

In a preferred embodiment, the secondary camera 46 may include a video conferencing camera or a video telephony module having an aperture disposed on the front side 13 of the housing 12, e.g., the side of the housing on which the display 14 is disposed. In one exemplary embodiment, the video telephony module includes suitable focusing optics 62, e.g., a zoom lens, for focusing and transmitting video conference images to suitable image-shifting optics (designated generally as 70). The image-shifting optics 70 may be configured to shift the image from the video telephony module to another or secondary portion of the common image sensor element 48.

It will be appreciated that a variety of suitable image-shifting optics configurations may be employed without departing from the scope of the present invention. In the exemplary embodiment illustrated in FIG. 4, the image-shifting optics 70 include a pair of prisms 72 that cooperate with each other and with the focusing lens 62 to direct the video telephony module images onto a secondary portion onto the common image sensor element 48. Of course, other image-shifting configurations or techniques may be employed, including, but not limited to, a series of mirrors, beam splitters/combiners, fiber optic focusing elements, and the like.

In a preferred embodiment, the dual camera module 42 is configured such that an aperture for the main camera is disposed on a first side of the phone housing, e.g., the rear side 15 of the phone housing 12, and the secondary camera aperture is disposed on an opposite side of the phone housing, e.g., a front side 13 of the phone housing 12. This configuration may be particularly suitable for a phone embodiment in which the phone has traditional camera functionality, e.g., the ability to capture still and/or moving images, in conjunction with video conferencing or video telephony functionality. However, it is to be appreciated that the dual camera module is not limited to this particular configuration. For example, both the main camera aperture and the secondary camera aperture may be disposed on a common side of the phone housing or on a side surface of the phone without departing from the scope of the present invention.

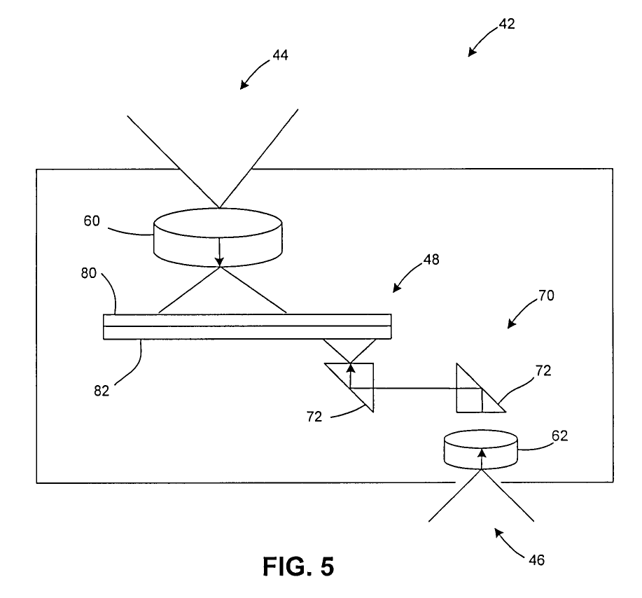

FIG. 5, in which like elements are represented by like reference numerals with respect to FIG. 4, depicts an alternative configuration of the dual camera module in which images from the secondary camera module 46, e.g., a video telephony module, are shifted onto a rear side or surface of the single or common image sensor element 48. This embodiment may be suitable where the dual camera module employs a double-sided common image sensor element 48. As is shown in FIG. 5, the illustrated common image sensor element 48 includes a first image sensor surface 80 and a second image sensor surface 82, where images from the main camera module 44 are focused on the first side or surface 82 of the common image sensor element and images from the secondary camera module 46 are focused on the second side or surface 82 of the common image sensor element 48.

It will be appreciated that the dual camera module described above may be employed in conjunction with a common image processor because (at least in the UMTS phone embodiment in which main camera functionality is coupled with video conferencing functionality), the main camera and the secondary camera would not be used at the same time. Further, the provision of the above-described dual camera module enables a lower profile camera module, which, in turn, may lead to a mobile phone having a lower or smaller profile housing.

Specific embodiments of an invention are disclosed herein. One of ordinary skill in the art will readily recognize that the invention may have other applications in other environments. In fact, many embodiments and implementations are possible. The following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A portable communication device comprising:
a housing;
a display supported within a portion of the housing; and
a dual camera module disposed within the housing, wherein the dual camera module comprises:
a first camera module positioned for capturing images adjacent to a first side of the housing;
a second camera module positioned for capturing images adjacent to a second side of the housing; and
a common image sensor element configured to receive images from the first camera module and the second camera module.

2. The portable communication device according to claim 1, wherein the first camera module is positioned to direct captured images onto a main portion of the common image sensor element

3. The portable communication device according to claim 2, wherein the dual camera module further comprises image-shifting optics configured to shift images from the second camera module onto a portion of the common image sensor element.

4. The portable communication device according to claim 1, wherein the first camera module includes a camera configured to capture still and/or moving images.

5. The portable communication device according to claim 4, wherein the second camera module is a video telephony module configured to capture video images.

6. The portable communication device according to claim 4, wherein the second camera module is configured to capture images of a user of the portable communication device for use in a video telephony communications session.

7. The portable communication device according to claim 1, wherein the first camera module includes a first camera aperture disposed within a rear side of the housing.

8. The portable communication device according to claim 7, wherein the second camera module includes a second camera aperture disposed within a front side of the housing; and
wherein the display is disposed on the front side of the housing.

9. The portable communication device according to claim 1, wherein the portable communication device is a mobile telephone.

10. A portable communication device comprising:
a housing; and
a dual camera module within the housing, the dual camera module comprising:
a main camera module;
a video telephony module; and
a common image sensor element configured to receive images from the main camera module and the video telephony module.

11. The portable communication according to claim 10, wherein the main camera module is configured to direct captured images onto a main portion of the common image sensor element.

12. The portable communication device according to claim 11, wherein the dual camera module includes image-shifting optics configured to shift images captured by the video telephony module onto a secondary portion of the common image sensor element.

13. The portable communication device according to claim 10, wherein the main camera module includes a main camera aperture disposed within a first side of the housing, and the video telephony module includes a video telephony aperture disposed within a second side of the housing.

14. The portable communication device according to claim 10, wherein the portable communication device is a mobile telephone.

15. A dual camera module for use with a portable communication device, the dual camera module comprising:
a main camera module configured to capture still and/or moving images;
a video telephony camera module configured to capture video images; and
a common image sensor element configured to receive images from the main camera module and the video telephony camera module.

16. The dual camera module according to claim 15, further comprising:
image-shifting optics configured to direct images from the video telephony camera module onto a secondary portion of the common image sensor element.

17. The dual camera module according to claim 16, wherein the main camera module is positioned to direct captured images onto a main portion of the common image sensor element

17. The dual camera module according to claim 15, further comprising:
image-shifting optics configured to direct images from the main camera module onto a secondary portion of the common image sensor element.

18. The dual camera module according to claim 17, wherein the video telephony camera module is positioned to direct captured images onto a main portion of the common image sensor element.

19. A mobile telephone comprising a housing that supports the dual camera module according to claim 15.
